(19) United States
(12) Patent Application Publication
(10) Pub. No.: US 2024/0062282 A1
(43) Pub. Date: Feb. 22, 2024

(54) METHOD AND SYSTEM FOR PAYMENT PROCESSING AND ACCOUNT SERVICES

(71) Applicant: JPMorgan Chase Bank, N.A., New York, NY (US)

(72) Inventors: Dinesh Babu PARTHASARATHI, Bournemouth (GB); Kevin LOBO, Wimborne (GB); Shankar RAJU, Erode (IN)

(73) Assignee: JPMorgan Chase Bank, N.A., New York, NY (US)

(21) Appl. No.: 17/956,499

(22) Filed: Sep. 29, 2022

(30) Foreign Application Priority Data
Aug. 17, 2022 (IN) 202211046710

(51) Int. Cl. G06Q 40/02

(52) U.S. Cl. CPC G06Q 40/02

(57) ABSTRACT

A method and system for payment processing and provision of account services using a cloud containerized platform that improves reliability and scalability are provided. The method includes receiving, at the cloud containerized platform from a server, a request that relates to a user account that has been received by the server from the user; analyzing a content of the first request; selecting, based on a result of the analysis, an application for responding to the request; generating a response to the request by using the selected application; and transmitting the response to the server to be forwarded to the user. The application may include any one of a payment processing application, an account information inquiry application, an account statement generation application, an account update notification application, an account information routing application, and/or a new client onboarding application.

### CROSS-REFERENCE TO RELATED APPLICATIONS

This application claims priority benefit from Indian Application No. 202211046710, filed Aug. 17, 2022, which is hereby incorporated by reference in its entirety.

### BACKGROUND

### 1. Field of the Disclosure

This technology generally relates to methods and systems for payment processing and provision of account services, and more particularly to methods and systems for payment processing and provision of account services using a cloud containerized platform that improves reliability and scalability and provides an increased customization capability.

### 2. Background Information

For a large financial institution that interacts with members of the public as clients, many operations involve payment processing and account services that are conducted widely on a daily basis. In addition, clients expect services to be tailored to their individual needs. As a result, it is important that these aspects be provided in an expeditious and reliable manner in order to preserve client confidence.

The use of cloud-based platforms for providing computer-implemented services has been increasing, because the cloud offers robustness and redundancy that effectively improves system speed and reliability. Accordingly, there is a need for a mechanism for payment processing and provision of account services using a cloud containerized platform that improves reliability and scalability and provides an increased customization capability.

### SUMMARY

The present disclosure, through one or more of its various aspects, embodiments, and/or specific features or sub-components, provides, inter alia, various systems, servers, devices, methods, media, programs, and platforms for payment processing and provision of account services using a cloud containerized platform that improves reliability and scalability and provides an increased customization capability.

According to an aspect of the present disclosure, a method for servicing an account associated with a user is provided. The method is implemented by a first processor that is hosted on a cloud-based platform. The method includes: receiving, by the first processor from a first server, a first request that relates to an account associated with a user, the first request being received by the first server from the user; analyzing, by the first processor, a content of the first request; selecting, by the first processor based on a result of the analyzing, at least a first application from among a predetermined set of applications for responding to the first request; generating, by the first processor, a first response to the first request by using the selected at least first application; and transmitting, by the first processor to the first server, the first response. The first processor is interoperably configured to coordinate with a second processor that is hosted on a different platform and that is configured to independently process the first request in order to generate a result that matches the first response.

The predetermined set of applications may include at least one from among a payment processing application, an account information inquiry application, an account statement generation application, an account update notification application, an account information routing application, and a new client onboarding application.

Each application included in the predetermined set of applications may be a Java-based application.

The first processor may be compatible with a Society for Worldwide Interbank Financial Telecommunication (SWIFT) system.

The first processor may be compatible with a Proxy Posting Service (PPS) system.

The method may further include displaying a graphical user interface (GUI) that includes information that relates to the account, information that relates to the first request, and information that relates to the first response.

The method may further include: when an error occurs during the generating of the first response, displaying, on the GUI, information that relates to the error.

The method may further include: receiving, from the first server in response to the transmitting of the first response, a second request that has been received by the first server from the user; analyzing a content of the second request; selecting, based on a result of the analyzing of the second request, at least a second application from among the predetermined set of applications for responding to the second request; generating a second response to the second request by using the selected at least second application; and transmitting, to the first server, the second response.

The method may further include: receiving, from the first server in response to the transmitting of the second response, at least one subsequent request that has been received by the first server from the user; analyzing a respective content of each of the at least one subsequent request; selecting, based on a result of the analyzing of the at least one subsequent request, at least a third application from among the predetermined set of applications for responding to the at least one subsequent request; generating at least one subsequent response to the at least one subsequent request by using the selected at least third application; and transmitting, to the first server, the at least one subsequent response.

According to another aspect of the present disclosure, a computing apparatus for servicing an account associated with a user is provided. The computing apparatus includes a first processor that is hosted on a cloud-based platform; a memory; a display; and a communication interface coupled to each of the processor, the memory, and the display. The first processor is configured to: receive, via the communication interface from a first server, a first request that relates to an account associated with a user, the first request being received by the first server from the user; analyze a content of the first request; select, by the at least one processor based on a result of the analysis, at least a first application from among a predetermined set of applications for responding to the first request; generate a first response to the first request by using the selected at least first application; and transmit, via the communication interface to the first server, the first response. The first processor is interoperably configured to coordinate with a second processor that is hosted on a different platform and that is configured to independently process the first request in order to generate a result that matches the first response.

The predetermined set of applications may include at least one from among a payment processing application, an account information inquiry application, an account statement generation application, an account update notification application, an account information routing application, and a new client onboarding application.

Each application included in the predetermined set of applications may be a Java-based application.

The first processor may be compatible with a Society for Worldwide Interbank Financial Telecommunication (SWIFT) system.

The first processor may be compatible with a Proxy Posting Service (PPS) system.

The first processor may be further configured to cause the display to display a graphical user interface (GUI) that includes information that relates to the account, information that relates to the first request, and information that relates to the first response.

The first processor may be further configured to: when an error occurs during the generation of the first response, cause the display to display, on the GUI, information that relates to the error.

The first processor may be further configured to: receive, via the communication interface from the first server in response to the transmitting of the first response, a second request that has been received by the first server from the user; analyze a content of the second request; select, based on a result of the analysis of the second request, at least a second application from among the predetermined set of applications for responding to the second request; generate a second response to the second request by using the selected at least second application; and transmit, to the first server via the communication interface, the second response.

The first processor may be further configured to: receive, via the communication interface from the first server in response to the transmitting of the second response, at least one subsequent request that has been received by the first server from the user; analyze a respective content of each of the at least one subsequent request; select, based on a result of the analysis of the at least one subsequent request, at least a third application from among the predetermined set of applications for responding to the at least one subsequent request; generate at least one subsequent response to the at least one subsequent request by using the selected at least third application; and transmit, to the first server via the communication interface, the at least one subsequent response.

According to yet another aspect of the present disclosure, a method for servicing an account associated with a user is provided. The method is implemented by a first processor. The method includes: receiving, by the first processor from a user, a first request that relates to an account associated with the user; forwarding, by the first processor to a first server that is hosted on a cloud-based platform, the first request; receiving, by the first processor from the first server, a first response to the first request; and transmitting, by the first processor to the user, the first response. The first server is configured to generate the first response by using at least one application from among a predetermined set of applications. The first processor is interoperably configured to coordinate with a second processor that is configured to independently process the first request in order to generate a result that matches the first response.

The predetermined set of applications may include at least one from among a payment processing application, an account information inquiry application, an account statement generation application, an account update notification application, an account information routing application, and a new client onboarding application.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for payment processing and provision of account services using a cloud containerized platform that improves reliability and scalability and provides an increased customization capability.

FIG. 4 is a flowchart of an exemplary process for implementing a method for payment processing and provision of account services using a cloud containerized platform that improves reliability and scalability and provides an increased customization capability.

FIG. 5 is a block diagram that illustrates data flows resulting from an execution of a method for payment processing and provision of account services using a cloud containerized platform that improves reliability and scalability and provides an increased customization capability, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

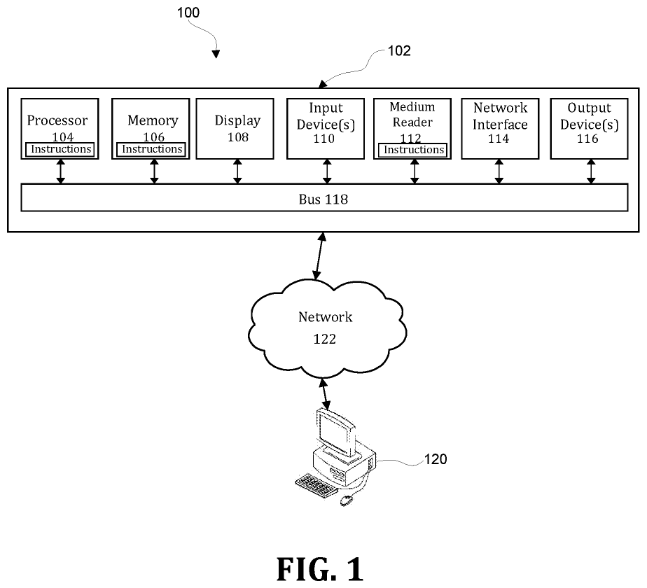

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for payment processing and provision of account services using a cloud containerized platform that improves reliability and scalability and provides an increased customization capability.

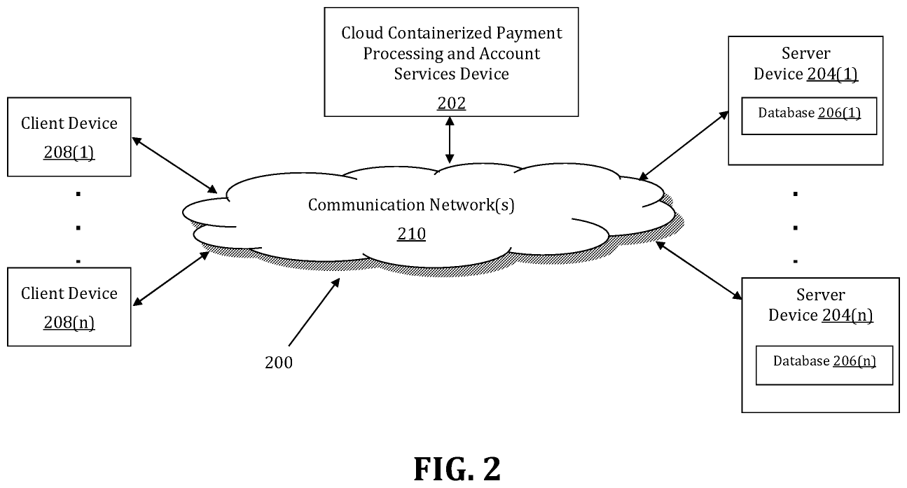

Referring to FIG. 2, a schematic of an exemplary network environment 200 for implementing a method for payment processing and provision of account services using a cloud containerized platform that improves reliability and scalability and provides an increased customization capability is illustrated. In an exemplary embodiment, the method is executable on any networked computer platform, such as, for example, a personal computer (PC).

The method for payment processing and provision of account services using a cloud containerized platform that improves reliability and scalability and provides an increased customization capability may be implemented by a Cloud Containerized Payment Processing and Account Services (CCPPAS) device 202. The CCPPAS device 202 may be the same or similar to the computer system 102 as described with respect to FIG. 1. The CCPPAS device 202 may store one or more applications that can include executable instructions that, when executed by the CCPPAS device 202, cause the CCPPAS device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CCPPAS device 202 itself, may be located in virtual server(s) running in a cloud-based computing environment rather than being tied to one or more specific physical network computing devices. Also, the application(s) may be running in one or more virtual machines (VMs) executing on the CCPPAS device 202. Additionally, in one or more embodiments of this technology, virtual machine(s) running on the CCPPAS device 202 may be managed or supervised by a hypervisor.

In the network environment 200 of FIG. 2, the CCPPAS device 202 is coupled to a plurality of server devices 204(1)-204(n) that hosts a plurality of databases 206(1)-206(n), and also to a plurality of client devices 208(1)-208(n) via communication network(s) 210. A communication interface of the CCPPAS device 202, such as the network interface 114 of the computer system 102 of FIG. 1, operatively couples and communicates between the CCPPAS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CCPPAS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CCPPAS devices that efficiently implement a method for payment processing and provision of account services using a cloud containerized platform that improves reliability and scalability and provides an increased customization capability.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CCPPAS device 202 may be a standalone device or integrated with one or more other devices or apparatuses, such as one or more of the server devices 204(1)-204(n), for example. In one particular example, the CCPPAS device 202 may include or be hosted by one of the server devices 204(1)-204(n), and other arrangements are also possible. Moreover, one or more of the devices of the CCPPAS device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CCPPAS device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical data that relates to client interactions and communications and data that relates to measurable payment processing and account servicing quality metrics and statistics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CCPPAS device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CCPPAS device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CCPPAS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CCPPAS device 202, the server devices 204(1)-204(n), or the client devices 208(1)-208(n), for example, may be configured to operate as virtual instances on the same physical machine. In other words, one or more of the CCPPAS device 202, the server devices 204(1)-204(n), or the client devices 208(1)-208(n) may operate on the same physical device rather than as separate devices communicating through communication network(s) 210. Additionally, there may be more or fewer CCPPAS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

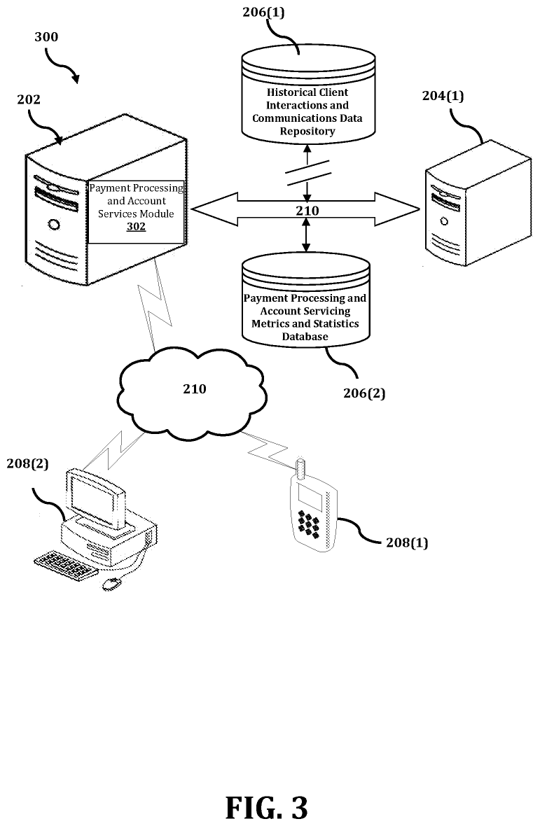

The CCPPAS device 202 is described and illustrated in FIG. 3 as including a payment processing and account services module 302, although it may include other rules, policies, modules, databases, or applications, for example. As will be described below, the payment processing and account services module 302 is configured to implement a method for payment processing and provision of account services using a cloud containerized platform that improves reliability and scalability and provides an increased customization capability.

An exemplary process 300 for implementing a mechanism for payment processing and provision of account services using a cloud containerized platform that improves reliability and scalability and an increased customization capability by utilizing the network environment of FIG. 2 is illustrated as being executed in FIG. 3. Specifically, a first client device 208(1) and a second client device 208(2) are illustrated as being in communication with CCPPAS device 202. In this regard, the first client device 208(1) and the second client device 208(2) may be “clients” of the CCPPAS device 202 and are described herein as such. Nevertheless, it is to be known and understood that the first client device 208(1) and/or the second client device 208(2) need not necessarily be “clients” of the CCPPAS device 202, or any entity described in association therewith herein. Any additional or alternative relationship may exist between either or both of the first client device 208(1) and the second client device 208(2) and the CCPPAS device 202, or no relationship may exist.

Further, CCPPAS device 202 is illustrated as being able to access a historical client interactions and communications data repository 206(1) and a payment processing and account servicing metrics and statistics database 206(2). The payment processing and account services module 302 may be configured to access these databases for implementing a method for payment processing and provision of account services using a cloud containerized platform that improves reliability and scalability and an increased customization capability.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CCPPAS device 202 via broadband or cellular communication. Of course, these embodiments are merely exemplary and are not limiting or exhaustive.

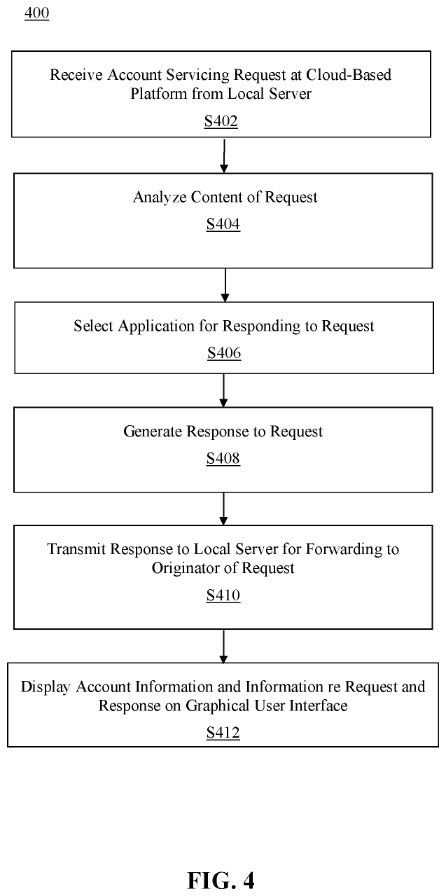

Upon being started, the payment processing and account services module 302 executes a process for payment processing and provision of account services using a cloud containerized platform that improves reliability and scalability and provides an increased customization capability. An exemplary process for payment processing and provision of account services using a cloud containerized platform that improves reliability and scalability and provides an increased customization capability is generally indicated at flowchart 400 in FIG. 4.

In process 400 of FIG. 4, at step S402, the payment processing and account services module 302 receives a first request that relates to an account associated with a user. The payment processing and account services module 302 is hosted on a cloud-based platform, and the first request is received from a local server that is in communication with the user and/or with an originator of the request. In an exemplary embodiment, the payment processing and account services module 302 and an associated processor that is hosted on the cloud-based platform is compatible with the Society for Worldwide Interbank Financial Telecommunication (SWIFT) system and also with a Proxy Posting Service (PPS) system. In an exemplary embodiment, the payment processing and account services module 302 is interoperably configured to coordinate with a processor that is hosted on a different platform and that is configured to independently process the first request.

At step S404, the payment processing and account services module 302 analyzes the content of the first request. Then, at step S406, the payment processing and account services module selects one or more applications that are suitable for responding to the first request, based on a result of the analysis performed in step S404. In an exemplary embodiment, the application(s) may be selected from a predetermined set of applications that includes one or more of the following: a payment processing application; an account information inquiry application; an account statement generation application; an account update notification application; an account information routing application; and a new client onboarding application. However, the predetermined set of application may further include any other type of application that is suitable for performing payment processing and/or account servicing functions.

In an exemplary embodiment, each application included in the predetermined set of applications may be a Java-based application.

At step S408, the payment processing and account services module 302 generates a first response to the first request by using the selected application(s). Then, at step S410, the payment processing and account services module 302 transmits the first response to the local server so that the first response can be forwarded to the originator of the request. In an exemplary embodiment, the interoperability of the payment processing and account services module 302 with the second processor that is hosted on a different platform and that is configured to independently process the first request ensures that the second processor generates a result that matches the first response.

At step S412, the payment processing and account services module 302 displays a graphical user interface (GUI) that includes information that relates to the account, information that relates to the first request, and information that relates to the first response. For example, the GUI may include an account owner name; other personal information about the account owner such as home address and demographic information such as date of birth and gender; an account number; an account type; a textual description of the content of the first request; and a textual description of the first response. However, the GUI may also include any other suitable type of information. Further, when an error occurs during the generating of the first response in step S408, then the GUI may also include information that relates to the error.

In an exemplary embodiment, after the first response has been transmitted to the local server in step S410, in many situations a second request may be submitted as a follow-up to the first response. In this circumstance, the payment processing and account services module 302 may repeat the process 400 in order to handle the second request and thereby generate a second response thereto that is transmitted to the local server for forwarding to the originator of the second request. In addition, subsequent requests may be received and subsequent responses may be generated by the payment processing and account services module 302 by repeating the process 400 as required.

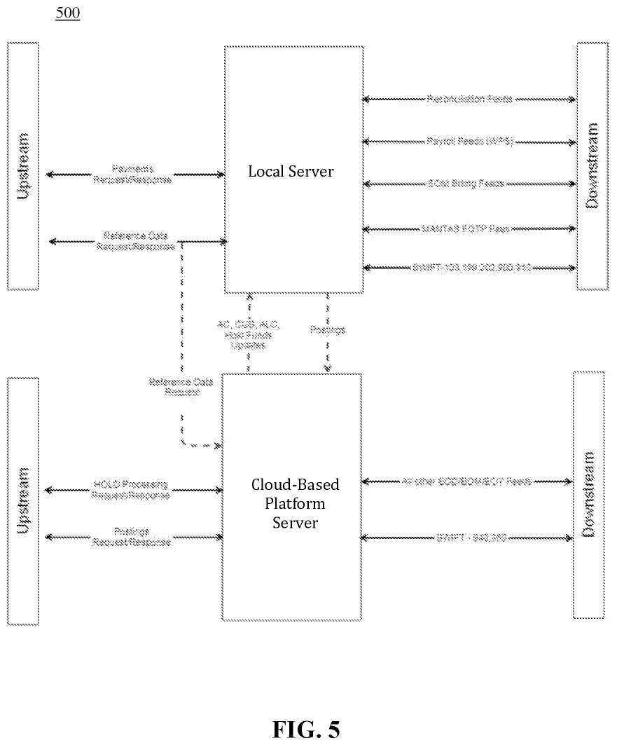

FIG. 5 is a block diagram 500 that illustrates data flows resulting from an execution of a method for payment processing and provision of account services using a cloud containerized platform that improves reliability and scalability and provides an increased customization capability, according to an exemplary embodiment. As illustrated in diagram 500, a local server is in communication with upstream users to send and receive requests and/or responses that relate to payments associated with user accounts and also to send and receive requests and/or responses that relate to reference data associated with the accounts. The local server is also in communication with downstream users with respect to various types of information associated with the accounts, such as reconciliation feeds, payroll feeds, end-of-month (EOM) billing feeds, MANTAS FOTP feeds, and communications associated with the SWIFT system.

Referring again to FIG. 5, the local server is also in communication with a cloud-based platform server. In an exemplary embodiment, the local server may forward reference data requests and postings to the cloud-based platform server, and may also receive AC, CUS, ALC, and hold funds updates from the cloud-based platform server. The cloud-based platform server communicates with upstream users with respect to hold processing requests and responses and also with respect to requests and responses relating to postings. The cloud-based platform server communicates with downstream users with respect to end-of-day (EOD), end-of-month (EOM), and end-of-year (EOY) feeds and also with respect to certain communications associated with the SWIFT system.

In an exemplary embodiment, the system and methodology described above enables a transformation from a lower release or an older release of a software module that handles requests relating to multiple business areas into an upgraded release or newer release of software modules that independently handle each business area. For example, for an older release of software that handles account services and payments, the optimized process for payment processing and provision of account services using a cloud containerized platform according to an exemplary embodiment may transform the lower release into an upgraded release by which the payments are independently handled by a new software module and the account services are independently handled by a different new software module, or by which one or the other of the payments and the account services are handled by a new software module while the other is handled by the older software module. In this aspect, the optimized process for payment processing and provision of account services using a cloud containerized platform according to an exemplary embodiment provides a systematic management of this transformation and allows for a seamless servicing process to a set of customers both before and after the transformation, such that the customers will not notice any such transformation.

Accordingly, with this technology, an optimized process for payment processing and provision of account services using a cloud containerized platform that improves reliability and scalability and an increased customization capability is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for servicing an account associated with a user, the method being implemented by a first processor that is hosted on a cloud-based platform, the method comprising:
receiving, by the first processor from a first server, a first request that relates to an account associated with a user, the first request being received by the first server from the user;
analyzing, by the first processor, a content of the first request;
selecting, by the first processor based on a result of the analyzing, at least a first application from among a predetermined set of applications for responding to the first request;
generating, by the first processor, a first response to the first request by using the selected at least first application; and
transmitting, by the first processor to the first server, the first response,
wherein the first processor is interoperably configured to coordinate with a second processor that is hosted on a different platform and that is configured to independently process the first request in order to generate a result that matches the first response.

2. The method of claim 1, wherein the predetermined set of applications includes at least one from among a payment processing application, an account information inquiry application, an account statement generation application, an account update notification application, an account information routing application, and a new client onboarding application.

3. The method of claim 1, wherein each application included in the predetermined set of applications is a Java-based application.

4. The method of claim 1, wherein the first processor is compatible with a Society for Worldwide Interbank Financial Telecommunication (SWIFT) system.

5. The method of claim 1, wherein the first processor is compatible with a Proxy Posting Service (PPS) system.

6. The method of claim 1, further comprising displaying a graphical user interface (GUI) that includes information that relates to the account, information that relates to the first request, and information that relates to the first response.

7. The method of claim 6, further comprising:
when an error occurs during the generating of the first response, displaying, on the GUI, information that relates to the error.

8. The method of claim 1, further comprising:
receiving, from the first server in response to the transmitting of the first response, a second request that has been received by the first server from the user;
analyzing a content of the second request;
selecting, based on a result of the analyzing of the second request, at least a second application from among the predetermined set of applications for responding to the second request;
generating a second response to the second request by using the selected at least second application; and
transmitting, to the first server, the second response.

9. The method of claim 8, further comprising:
receiving, from the first server in response to the transmitting of the second response, at least one subsequent request that has been received by the first server from the user;
analyzing a respective content of each of the at least one subsequent request;
selecting, based on a result of the analyzing of the at least one subsequent request, at least a third application from among the predetermined set of applications for responding to the at least one subsequent request;
generating at least one subsequent response to the at least one subsequent request by using the selected at least third application; and
transmitting, to the first server, the at least one subsequent response.

10. A computing apparatus for servicing an account associated with a user, the computing apparatus comprising:
a first processor that is hosted on a cloud-based platform;
a memory;
a display; and
a communication interface coupled to each of the first processor, the memory, and the display,
wherein the first processor is configured to:
receive, via the communication interface from a first server, a first request that relates to an account associated with a user, the first request being received by the first server from the user;
analyze a content of the first request;
select, by the at least one processor based on a result of the analysis, at least a first application from among a predetermined set of applications for responding to the first request;
generate a first response to the first request by using the selected at least first application; and
transmit, via the communication interface to the first server, the first response,
wherein the first processor is interoperably configured to coordinate with a second processor that is hosted on a different platform and that is configured to independently process the first request in order to generate a result that matches the first response.

11. The computing apparatus of claim 10, wherein the predetermined set of applications includes at least one from among a payment processing application, an account information inquiry application, an account statement generation application, an account update notification application, an account information routing application, and a new client onboarding application.

12. The computing apparatus of claim 10, wherein each application included in the predetermined set of applications is a Java-based application.

13. The computing apparatus of claim 10, wherein the first processor is compatible with a Society for Worldwide Interbank Financial Telecommunication (SWIFT) system.

14. The computing apparatus of claim 10, wherein the first processor is compatible with a Proxy Posting Service (PPS) system.

15. The computing apparatus of claim 10, wherein the first processor is further configured to cause the display to display a graphical user interface (GUI) that includes information that relates to the account, information that relates to the first request, and information that relates to the first response.

16. The computing apparatus of claim 15, wherein the first processor is further configured to:
when an error occurs during the generation of the first response, cause the display to display, on the GUI, information that relates to the error.

17. The computing apparatus of claim 10, wherein the first processor is further configured to:
receive, via the communication interface from the first server in response to the transmitting of the first response, a second request that has been received by the first server from the user;
analyze a content of the second request;
select, based on a result of the analysis of the second request, at least a second application from among the predetermined set of applications for responding to the second request;
generate a second response to the second request by using the selected at least second application; and
transmit, to the first server via the communication interface, the second response.

18. The computing apparatus of claim 17, wherein the first processor is further configured to:
receive, via the communication interface from the first server in response to the transmitting of the second response, at least one subsequent request that has been received by the first server from the user;
analyze a respective content of each of the at least one subsequent request;
select, based on a result of the analysis of the at least one subsequent request, at least a third application from among the predetermined set of applications for responding to the at least one subsequent request;
generate at least one subsequent response to the at least one subsequent request by using the selected at least third application; and
transmit, to the first server via the communication interface, the at least one subsequent response.

19. A method for servicing an account associated with a user, the method being implemented by a first processor, the method comprising:
receiving, by the first processor from a user, a first request that relates to an account associated with the user;
forwarding, by the first processor to a first server that is hosted on a cloud-based platform, the first request;
receiving, by the first processor from the first server, a first response to the first request; and
transmitting, by the first processor to the user, the first response,
wherein the first server is configured to generate the first response by using at least one application from among a predetermined set of applications, and
wherein the first processor is interoperably configured to coordinate with a second processor that is configured to independently process the first request in order to generate a result that matches the first response.

20. The method of claim 19, wherein the predetermined set of applications includes at least one from among a payment processing application, an account information inquiry application, an account statement generation application, an account update notification application, an account information routing application, and a new client onboarding application.
